(19) United States
(12) Patent Application Publication
(10) Pub. No.: US 2017/0355230 A1
(43) Pub. Date: Dec. 14, 2017

(54) Pneumatic Tire

(71) Applicant: The Yokohama Rubber Co., LTD., Tokyo (JP)

(72) Inventor: Takayuki Suzuki, Hiratsuka-shi (JP)

(73) Assignee: The Yokohama Rubber Co., LTD.

(21) Appl. No.: 15/618,038

(22) Filed: Jun. 8, 2017

(30) Foreign Application Priority Data
Jun. 13, 2016 (JP) 2016-117261

(51) Int. Cl. B60C 9/30; B60C 9/20

(52) U.S. Cl. CPC B60C 9/30; B60C 9/20; B60C 2009/2019; B60C 2009/2022; B60C 2009/2016

(57) ABSTRACT

A pneumatic tire includes a tread portion, and a belt layer including a plurality of belt plies on an inner side in a tire radial direction of the tread portion. In such a pneumatic tire, a mounting direction of the pneumatic tire on a vehicle is specified; the belt layer includes a circumferential reinforcing layer, circumferential reinforcing layer cords being disposed side by side in a tire width direction in the circumferential reinforcing layer, the circumferential reinforcing layer cords being inclined with respect to a tire circumferential direction within a range of ±5° in the tire width direction; and a cord count, namely a number of the circumferential reinforcing layer cords in the tire width direction, of the circumferential reinforcing layer is greater on an inner side in a vehicle mounting direction than on an outer side in the vehicle mounting direction, based on a tire equatorial plane.

### PRIORITY CLAIM

Priority is claimed to Japan Patent Application Serial No. 2016-117261 filed on Jun. 13, 2016.

### TECHNICAL FIELD

The present technology relates to a pneumatic tire.

### BACKGROUND ART

In pneumatic tires, belts and breakers, which ensure the strength of the ground contact surface and reinforce the carcass, are disposed on the inner side in the tire radial direction of the tread. These belts and breakers are formed by disposing rubber coated cords formed from steel or the like at an orientation inclined with respect to the tire circumferential direction. Additionally, there are conventional pneumatic tires in which the belt and/or breaker is designed so as to ensure a desired performance factor.

For example, in the pneumatic tire stated in Japanese Unexamined Patent Application Publication No. H03-217303A, an overlap width between band strips of a breaker insert is configured to differ between regions where tire profile stiffness is high and regions where tire profile stiffness is low in order to suppress unnecessary radial growth during tire rotation. Additionally, in the pneumatic tire stated in Japanese Unexamined Patent Application Publication No. H06-278409A, tire circumferential direction rigidity of a belt reinforcing layer is configured to differ between both sides in the tire width direction, and the side where rigidity of the belt reinforcing layer is high is configured to differ between the front wheels and the rear wheels in order to enhance steering stability and riding comfort. Moreover, in the pneumatic tire stated in Japanese Unexamined Patent Application Publication No. 2015-58788A, the rigidity of an outside shoulder region of a belt reinforcing layer is configured to be greater than that of an inside shoulder region, and the rigidity of an inside center region is configured to be greater than the rigidity of an outside center region in order to ensure high steering stability without causing reductions in straight ahead stability and uniformity.

In recent years, in large trucks and buses, demand for using single mounted pneumatic tires instead of dual mounted pneumatic tires as pneumatic tires to be mounted on drive shafts and trailer shafts has increased. Reasons for the increased demand include improving fuel efficiency and reducing weight to improve transport efficiency. However, compared to dual mounted pneumatic tires, single mounted pneumatic tires have a wide developed tread width. Consequently, it is more likely that differences in ground contact pressure in each region in the tire width direction will increase and, as a result, uneven wear is more likely to occur.

For example, with large trucks and buses, the camber angle of the wheel is often set to a positive camber. In such cases, the ground contact pressure in the vicinity of the shoulder portion on the inner side in the vehicle mounting direction is likely to be lower than the ground contact pressure in the vicinity of the shoulder portion on the outer side surface in the vehicle mounting direction. When the ground contact pressure is low, radial growth due to rotation of the wheel when the vehicle is traveling is great and, consequently, it is more likely that radial growth in the vicinity of the shoulder portion on the inner side in the vehicle mounting direction will be greater than the radial growth in the vicinity of the shoulder portion on the outer side in the vehicle mounting direction. When radial growth is great, the degree of rubbing of the tread surface against the road surface when the wheel is rotating increases and, consequently, it is more likely that wear will occur. As such, in cases where the radial growth in the vicinity of the shoulder portion on the inner side in the vehicle mounting direction is great, wear is more likely to occur in the vicinity of the shoulder portion on the inner side in the vehicle mounting direction. As a result, in pneumatic tires to be single mounted on large trucks and buses, it is more likely that the wear in the vicinity of the shoulder portion on the inner side in the vehicle mounting direction will be greater than the wear in the vicinity of the shoulder portion on the outer side in the vehicle mounting direction and, consequently, uneven wear is more likely to occur.

### SUMMARY

The present technology provides a pneumatic tire whereby uneven wear on the inner side in the vehicle mounting direction can be suppressed.

A pneumatic tire according to a first aspect of the present technology includes a tread portion, and a belt layer including a plurality of belt plies on an inner side in a tire radial direction of the tread portion. In such a pneumatic tire, a mounting direction of the pneumatic tire on a vehicle is specified; the belt layer includes a circumferential reinforcing layer, cords being disposed side by side in a tire width direction in the circumferential reinforcing layer, the cords being inclined with respect to a tire circumferential direction within a range of ±5° in the tire width direction; and a cord count, namely a number of the cords in the tire width direction, of the circumferential reinforcing layer is greater on an inner side in a vehicle mounting direction than on an outer side in the vehicle mounting direction, based on a tire equatorial plane.

In the pneumatic tire according to the first aspect, it is preferable that a relationship between an average value Nin of the cord count of the cords on the inner side in the vehicle mounting direction and an average value Nout of the cord count of the cords on the outer side in the vehicle mounting direction of the circumferential reinforcing layer be such that 1.015≦(Nin/Nout)≦1.170.

Additionally, in the pneumatic tire according to the first aspect, it is preferable that the circumferential reinforcing layer include a reinforcing region, namely a region where an average cord count of the cords is greater than an average cord count of the cords in a range from an edge portion on the outer side in the vehicle mounting direction to 50 mm inward in the tire width direction, in a predetermined range inward in the tire width direction from an edge portion on the inner side in the vehicle mounting direction; and a relationship between a width Win in the tire width direction of the reinforcing region and a width W in the tire width direction of the circumferential reinforcing layer be such that 0.05<(Win/W)≦0.30.

Additionally, in the pneumatic tire according to the first aspect, it is preferable that a relationship between the width W in the tire width direction of the circumferential reinforcing layer and a developed tread width T be such that 0.7<(W/T)≦0.8.

Additionally, in the pneumatic tire according to the first aspect, it is preferable that a cord count of the cords of the circumferential reinforcing layer per 50 mm in the tire width direction in the region on the inner side in the vehicle mounting direction be not less than 20 cords and not greater than 25 cords.

Additionally, in the pneumatic tire according to the first aspect, it is preferable that the cords of the circumferential reinforcing layer be cords having high elongation characteristics, and that are obtained by twisting together a plurality of strands formed by a plurality of wires that are twisted together.

The pneumatic tire according to the present technology provides the advantageous effect of suppressing uneven wear on the inner side in the vehicle mounting direction.

### BRIEF DESCRIPTION OF DRAWINGS

FIG. 1 is a meridian cross-sectional view illustrating main constituents of a pneumatic tire according to an embodiment.

FIG. 2 is an explanatory drawing of the belt layer illustrated in FIG. 1.

FIG. 3 is a detailed view of portion A of FIG. 1.

FIG. 4 is a detailed view of portion B of FIG. 3.

FIG. 5 is a cross-sectional view of a circumferential reinforcing layer cord.

FIG. 6 is an explanatory diagram showing a stress-strain curve of the circumferential reinforcing layer cord.

FIG. 7 is an explanatory diagram of a modified example of the pneumatic tire according to the embodiment, illustrating a case in which the reinforcing region is provided throughout the entire inner side in the vehicle mounting direction.

FIG. 8A is a table showing the results of performance tests of pneumatic tires.

FIG. 8B is a table showing the results of performance tests of pneumatic tires.

FIG. 8C is a table showing the results of performance tests of pneumatic tires.

### DETAILED DESCRIPTION

A pneumatic tire according to an embodiment of the present technology is stated in detail below with reference to the drawings. However, the present technology is not intended to be limited by the embodiment. Furthermore, constituents of the following embodiment include elements that are essentially identical or that are obvious and can be substituted by one skilled in the art.

In the following description, “tire width direction” refers to a direction that is parallel with a rotational axis of a pneumatic tire, “inward in the tire width direction” refers to a direction toward a tire equatorial plane in the tire width direction, and “outward in the tire width direction” refers to a direction away from the tire equatorial plane in the tire width direction. Furthermore, “tire radial direction” refers to a direction orthogonal to the rotational axis of the tire; “inward in the tire radial direction” refers to a direction toward the rotational axis of the tire in the tire radial direction; and “outward in the tire radial direction” refers to a direction away from the rotational axis of the tire in the tire radial direction. Moreover, “tire circumferential direction” refers to the direction of rotation about the rotational axis of the tire.

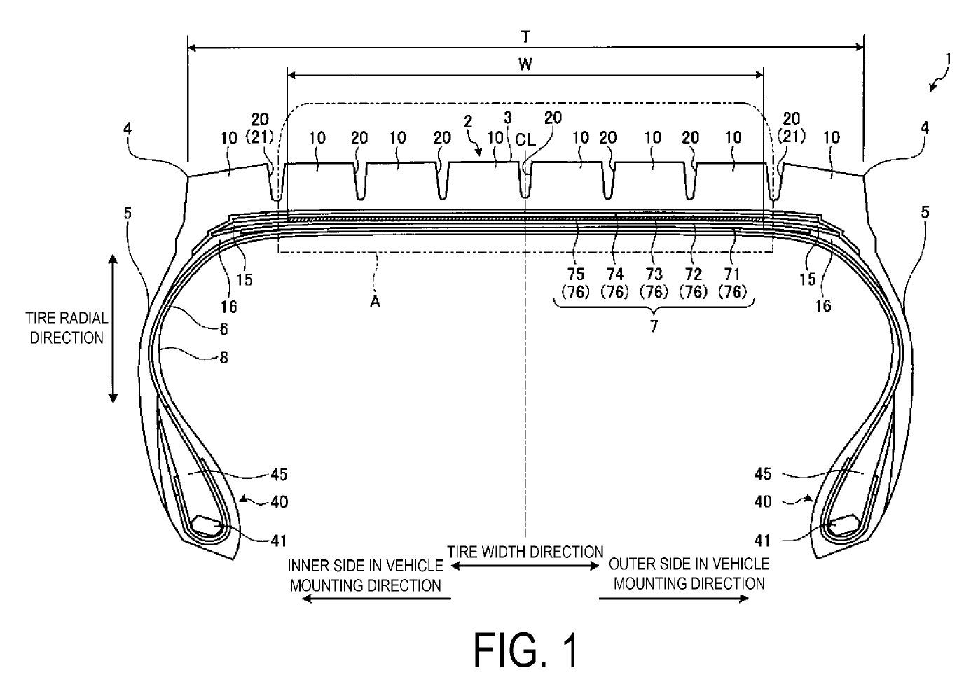

FIG. 1 is a meridian cross-sectional view illustrating main constituents of a pneumatic tire according to the present embodiment. The mounting direction of the pneumatic tire 1 illustrated in FIG. 1 on a vehicle, that is, the direction of the pneumatic tire 1 when mounted on a vehicle, is specified. Additionally, the pneumatic tire 1 includes a mounting direction indicator (not illustrated in the drawings) that indicates the mounting direction on the vehicle. The mounting direction indicator is constituted by marks or recesses and protrusions provided on the side wall portion of the tire. For example, European Economic Commission Regulation No. 30 (ECER30) requires that a mounting direction indicator be provided on the sidewall portion that constitutes the outer side in the vehicle mounting direction of the pneumatic tire when in a mounted state. Additionally, the pneumatic tire 1 according to the present embodiment is a heavy duty pneumatic tire intended for mounting on a large vehicle such as a long-distance transport truck, or a bus.

When viewing the pneumatic tire 1 according to the present embodiment in a meridian cross-sectional view, a tread portion 2 is disposed in a portion that is outermost in the tire radial direction, and a surface of the tread portion 2, that is, the portion that contacts the road surface when the vehicle (not illustrated in the drawings) on which the pneumatic tire 1 is mounted is traveling, is formed as a tread surface 3. A plurality of circumferential main grooves 20 extending in the tire circumferential direction is formed in the tread surface 3, and a plurality of lug grooves (not illustrated in the drawings) that intersect the circumferential main grooves 20 is also formed in the tread surface 3. A plurality of land portions 10 are partitioned in the tread surface 3 by the plurality of circumferential main grooves 20 and lug grooves.

Note that, the circumferential main grooves 20 in this case are grooves extending in the tire circumferential direction that have a groove width of not less than 6 mm and not greater than 14 mm, and a groove depth of not less than 10 mm and not greater than 26 mm. Additionally, it is not necessary that the circumferential main grooves 20 extend strictly in the tire circumferential direction, and may curve and bend in the tire width direction while extending in the tire circumferential direction. In the present embodiment, seven circumferential main grooves 20 are formed side by side, separated by intervals in the tire width direction. Additionally, the land portions 10 are formed between the circumferential main grooves 20 and also outward in the tire width direction of outermost circumferential main grooves 21, which are the circumferential main grooves 20 positioned outermost in the tire width direction.

Both ends in the tire width direction of the tread portion 2 are formed as shoulder portions 4, and sidewall portions 5 are disposed from the shoulder portions 4 to a predetermined position inward in the tire radial direction. In other words, the sidewall portion 5 is disposed at two locations on both sides in the tire width direction of the pneumatic tire 1.

Furthermore, a bead portion 40 is positioned on the inner side in the tire radial direction of each of the sidewall portions 5 and, as with the sidewall portion 5, the bead portion 40 is disposed at two locations on both sides of the tire equatorial plane CL. In other words, a pair of bead portions 40 is disposed on both sides of the tire equatorial plane CL in the tire width direction. A bead core 41 is provided in each of the pair of bead portions 40, and a bead filler 45 is provided on the outer side in the tire radial direction of each of the bead cores 41. The bead core 41 is formed by a bead wire, which is a steel wire, wound into an annular structure. The bead filler 45 is a rubber material that is disposed in space formed by an end in the tire width direction of the carcass 6 (stated later) being folded back outward in the tire width direction at the position of the bead core 41.

A belt layer 7 including a plurality of belt plies 76 is provided inward in the tire radial direction of the tread portion 2. The belt layer 7 has a multi-layer structure formed by layering the plurality of belt plies 76. Each of the belt plies 76 is constituted from a plurality of belt cords that have been coated with rubber and subjected to a rolling process. The belt cords are formed from steel or an organic fiber material such as polyester, rayon, or nylon. Additionally, the plurality of belt plies 76 are configured as a so-called crossply structure and are layered such that belt angles, which are defined as inclination angles of the belt cords in the tire width direction with respect to the tire circumferential direction, differ from each other, and the inclination directions of the belt cords cross each other.

The carcass 6, which contains radial ply cords, is provided continuously on the inner side in the tire radial direction of the belt layer 7 and on the tire equatorial plane CL side of the sidewall portions 5. The carcass 6 may have a single layer structure formed from one carcass ply or a multi-layer structure formed by layering a plurality of carcass plies. The carcass 6 is bridged between the bead cores 41 disposed on both sides in the tire width direction in a toroidal form, and constitutes the backbone of the tire. Specifically, the carcass 6 is disposed from one bead portion 40 of the pair of bead portions 40 positioned on both sides in the tire width direction to the other bead portion 40 and, at each of the bead portions 40, is wrapped back outward in the tire width direction along the bead core 41 so as to envelop the bead core 41 and the bead filler 45. The carcass plies of the carcass 6 disposed in this manner are constituted by a plurality of carcass cords formed from steel or an organic fiber material (for example, nylon, polyester, rayon, or the like) covered by coating rubber and subjected to a rolling process. The carcass 6 is formed such that a carcass angle of the carcass 6, namely an inclination angle in the tire width direction of the carcass cords with respect to the tire circumferential direction, is not less than 85° and not greater than 95° as an absolute value.

Additionally, an inner liner 8 is formed along the carcass 6 on an inner side of the carcass 6 or on the interior side of the carcass 6 in the pneumatic tire 1.

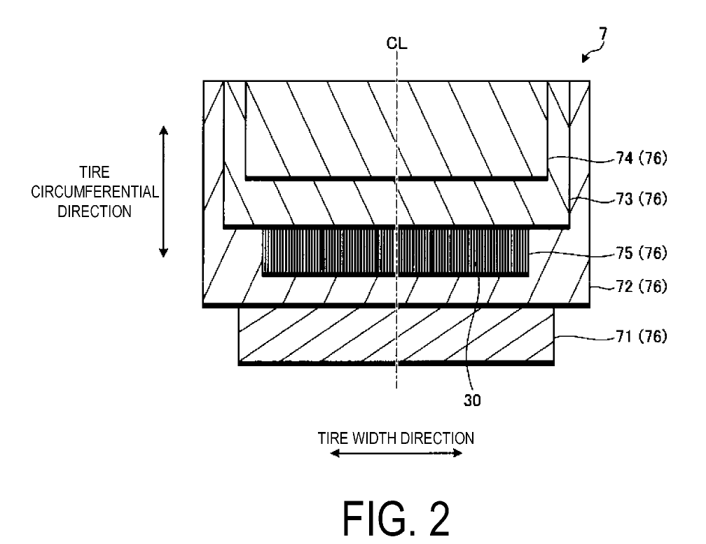

FIG. 2 is an explanatory drawing of the belt layer illustrated in FIG. 1. The belt layer 7 includes a large-angle belt 71, an inner cross belt 72, an outer cross belt 73, a belt cover 74, and a circumferential reinforcing layer 75 as the belt plies 76, and is constituted by layering these constituents in the tire radial direction. Of these constituents, the large-angle belt 71 is constituted by a plurality of belt cords formed from steel or an organic fiber material covered by coating rubber and subjected to a rolling process. Additionally, a belt angle of the large-angle belt 71, namely an inclination angle in the tire width direction of the belt cords with respect to the tire circumferential direction, is not less than 45° and not greater than 70° as an absolute value. Moreover, the large-angle belt 71 is disposed in a layered manner outward in the tire radial direction from the carcass 6.

The inner cross belt 72 and the outer cross belt 73 are each constituted by a plurality of belt cords formed from steel or an organic fiber material covered by coating rubber and subjected to a rolling process. The inner cross belt 72 and the outer cross belt 73 have a belt angle of not less than 10° and not greater than 45° as an absolute value. Additionally, inclination directions of the belt cords in the tire width direction with respect to the tire circumferential direction of the inner cross belt 72 and the outer cross belt 73 are mutually opposite directions. As such, the inner cross belt 72 and the outer cross belt 73 form a so-called crossply structure in which the cross belts are layered such that the inclination directions of the belt cords cross each other. Thus, the inner cross belt 72 and the outer cross belt 73 are provided as a pair of cross belts in which the inclination directions of the belt cords cross each other. The inner cross belt 72 and the outer cross belt 73 that are provided as a pair of cross belts in this manner are both positioned outward in the tire radial direction from the large-angle belt 71, and the outer cross belt 73 is positioned outward in the tire radial direction from the inner cross belt 72. Note that in the present embodiment, two cross belts, namely the inner cross belt 72 and the outer cross belt 73, are used, but a configuration is possible in which three or more cross belts are layered.

The belt cover 74 is constituted by a plurality of belt cords formed from steel or an organic fiber material covered by coating rubber and subjected to a rolling process. The belt cover 74 has a belt angle of not less than 10° and not greater than 45° as an absolute value. Additionally, the belt cover 74 is disposed in a layered manner outward in the tire radial direction from the inner cross belt 72 and the outer cross belt 73. Specifically, the belt cover 74 is disposed outward in the tire radial direction from the outer cross belt 73. Note that in the present embodiment, the belt angle of the belt cover 74 is the same as the belt angle of the outer cross belt 73, and the belt cover 74 is disposed as the outermost layer of the belt layer 7.

The circumferential reinforcing layer 75 is formed by winding circumferential reinforcing layer cords 30, which are cords that constitute the circumferential reinforcing layer 75, in a spiral manner with an inclination within a range of ±5° in the tire width direction with respect to the tire circumferential direction. The circumferential reinforcing layer cords 30 are steel belt cords covered with coating rubber. As such, the circumferential reinforcing layer cords 30 of the circumferential reinforcing layer 75 are disposed side by side in the tire width direction in a meridian cross-section of the pneumatic tire 1 and in a predetermined range in tire circumferential direction. Additionally, in the present embodiment, the circumferential reinforcing layer 75 is disposed between the inner cross belt 72 and the outer cross belt 73 in the tire radial direction, and is disposed so as to be interposed between the inner cross belt 72 and the outer cross belt 73.

The width in the tire width direction of the circumferential reinforcing layer 75 is narrower than the widths of the inner cross belt 72 and the outer cross belt 73, and the circumferential reinforcing layer 75 is disposed inward in the tire width direction of the end portions in the tire width direction of the inner cross belt 72 and the outer cross belt 73. With the circumferential reinforcing layer 75 having the width in the tire width direction that is narrower than the widths of the inner cross belt 72 and the outer cross belt 73, a relationship between a width W in the tire width direction of the circumferential reinforcing layer 75 and a developed tread width T is such that 0.7≦(W/T)≦0.8 (see FIG. 1). That is, the circumferential reinforcing layer 75 is formed such that the width W in the tire width direction is not less than 0.7 times and not greater than 0.8 times the developed tread width T. Here, the term “developed tread width T” refers to the linear distance in the tire width direction in a developed view of the tread portion 2 when the pneumatic tire 1 is assembled on a specified rim, inflated with air to a specified internal pressure, and in an unloaded state.

Herein, “specified rim” refers to an “applicable rim” as defined by the Japan Automobile Tyre Manufacturers Association Inc. (JATMA), a “Design Rim” as defined by the Tire and Rim Association, Inc. (TRA), or a “Measuring Rim” as defined by the European Tyre and Rim Technical Organisation (ETRTO). Additionally, “specified internal pressure” refers to a “maximum air pressure” as defined by JATMA, to the maximum value in “TIRE LOAD LIMITS AT VARIOUS COLD INFLATION PRESSURES” as defined by TRA, and to “INFLATION PRESSURES” as defined by ETRTO.

The circumferential reinforcing layer 75 configured in this manner is formed by spirally winding one or a plurality of the circumferential reinforcing layer cords 30 on the outer circumference of the inner cross belt 72. This circumferential reinforcing layer 75 reinforces the rigidity in the tire circumferential direction. As a result, durability performance of the pneumatic tire 1 can be improved.

A belt edge cushion 15 made from a rubber material is disposed outward in the tire width direction from the circumferential reinforcing layer 75 (see FIG. 1). The belt edge cushion 15 is disposed between the inner cross belt 72 and the outer cross belt 73, at a position farther outward in the tire width direction than the circumferential reinforcing layer 75, and is interposed between the inner cross belt 72 and the outer cross belt 73. Additionally, the belt edge cushion 15 is provided so as to extend from the vicinity of the end portion in the tire width direction of the circumferential reinforcing layer 75 to positions of the end portions in the tire width direction of the inner cross belt 72 and the outer cross belt 73.

A belt cushion 16 is disposed between the vicinity of the end portion in the tire width direction of the belt layer 7 and the carcass 6 (see FIG. 1). Specifically, the belt cushion 16 is disposed so as to be interposed between the carcass 6 and the vicinity of the end portions in the tire width direction of the inner cross belt 72 and the large-angle belt 71, and is disposed along the carcass 6 from a position inward in the tire width direction to a position outward in the tire width direction of these end portions. In other words, the belt cushion 16 is disposed from positions in the vicinity of both ends in the tire width direction of the tread portion 2 to positions in the vicinity of the outer ends in the tire radial direction of the sidewall portions 5.

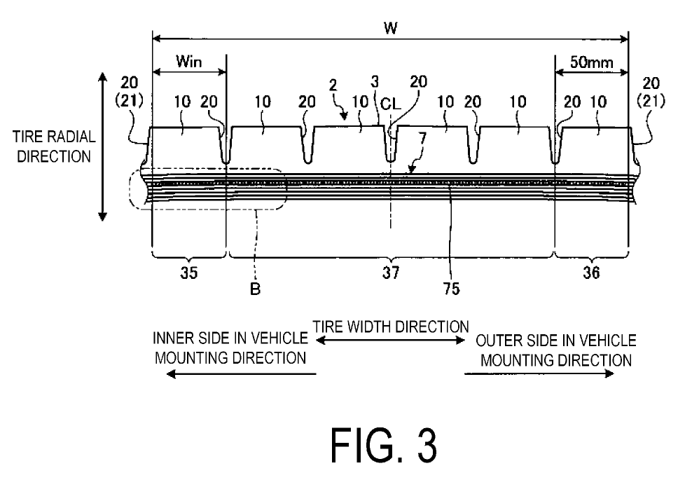

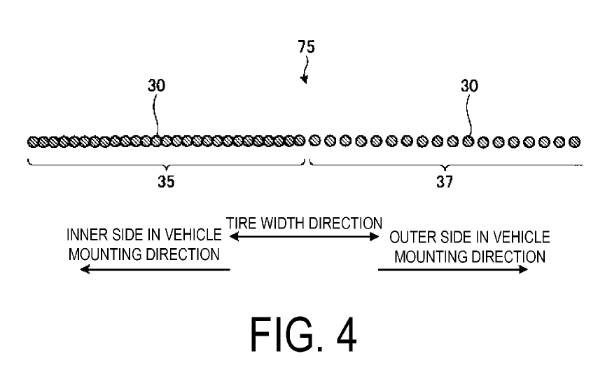

FIG. 3 is a detailed view of portion A of FIG. 1. FIG. 4 is a detailed view of portion B of FIG. 3. The cord count, namely the number of the circumferential reinforcing layer cords 30 in the tire width direction, of the circumferential reinforcing layer 75 that has the function of reinforcing the rigidity in the tire circumferential direction of the pneumatic tire 1, is configured to be greater on an inner side in the vehicle mounting direction than on the outer side in the vehicle mounting direction, based on a tire equatorial plane. In other words, with the circumferential reinforcing layer 75, the circumferential reinforcing layer cords 30 are disposed side by side in the tire width direction, and the average number of the circumferential reinforcing layer cords 30 per predetermined width in the tire width direction is greater on the inner side in the vehicle mounting direction than on the outer side in the vehicle mounting direction. Specifically, in the circumferential reinforcing layer 75, a relationship between an average value Nin of the cord count per the predetermined width in the tire width direction of the circumferential reinforcing layer cords 30 on the inner side in the vehicle mounting direction and an average value Nout of the cord count per the predetermined width of the circumferential reinforcing layer cords 30 on the outer side in the vehicle mounting direction is such that 1.015≦(Nin/Nout)≦1.170. For example, the cord count of the circumferential reinforcing layer cords 30 per 50 mm in the tire width direction is configured such that the relationship between the average value Nin on the inner side in the vehicle mounting direction and the average value Nout on the outer side in the vehicle mounting direction is 1.015≦(Nin/Nout)≦1.170. Note that it is more preferable that the relationship between the average value Nin of the cord count of the circumferential reinforcing layer cords 30 on the inner side in the vehicle mounting direction and the average value Nout of the cord count of the circumferential reinforcing layer cords 30 on the outer side in the vehicle mounting direction be such that 1.030≦(Nin/Nout)≦1.095.

Specifically, the circumferential reinforcing layer 75 includes a reinforcing region 35 within a predetermined range inward in the tire width direction from the end portion on the inner side in the vehicle mounting direction. The reinforcing region 35 is a region where the average cord count of the circumferential reinforcing layer cords 30 is greater than that of other regions in the tire width direction of the circumferential reinforcing layer 75. For example, the reinforcing region 35 is configured so as to have a greater average cord count of the circumferential reinforcing layer cords 30 than the average cord count of the circumferential reinforcing layer cords 30 in an outer region 36, which is a region in a range 50 mm inward in the tire width direction from the end portion on the outer side in the vehicle mounting direction. That is, the interval between the circumferential reinforcing layer cords 30 that are adjacent in the tire width direction in the reinforcing region 35 is reduced so as to be smaller than the interval between the circumferential reinforcing layer cords 30 in the outer region 36. Thus, the average cord count of the circumferential reinforcing layer cords 30 in the reinforcing region 35 is configured to be greater than the average cord count of the circumferential reinforcing layer cords 30 in the outer region 36.

Note that, by definition, the reinforcing region 35 is a region in which the average cord count of the circumferential reinforcing layer cords 30 is greater than the average cord count of the circumferential reinforcing layer cords 30 in the outer region 36, but the average cord count of the circumferential reinforcing layer cords 30 in the reinforcing region 35 is also configured to be greater than the average cord count of the circumferential reinforcing layer cords 30 in regions other than the outer region 36. That is, the reinforcing region 35 is configured such that the average cord count of the circumferential reinforcing layer cords 30 is greater than an average cord count of the circumferential reinforcing layer cords 30 in a central region 37. The central region 37 is a region positioned between the reinforcing region 35 and the outer region 36 in the circumferential reinforcing layer 75. In other words, the average cord count of the circumferential reinforcing layer cords 30 in the reinforcing region 35 is greater than the average cord counts of the circumferential reinforcing layer cords 30 in regions of the circumferential reinforcing layer 75 other than the reinforcing region 35.

With the reinforcing region 35 provided in this manner in the circumferential reinforcing layer 75, a relationship between a width Win in the tire width direction of the reinforcing region 35 and the width W in the tire width direction of the circumferential reinforcing layer 75 is such that 0.05≦(Win/W)≦0.30. That is, the reinforcing region 35 is configured such that the width Win in the tire width direction is not less than 0.05 times and not greater than 0.30 times the width W in the tire width direction of the circumferential reinforcing layer 75. Additionally, it is preferable that a relationship between the width Win in the tire width direction of the reinforcing region 35 and the width W in the tire width direction of the circumferential reinforcing layer 75 be such that 0.10≦(Win/W)≦0.20. Specifically, it is preferable that the width Win in the tire width direction of the reinforcing region 35 be not less than 30 mm and not greater than 60 mm.

In the present embodiment, the reinforcing region 35 is provided on the inner side in the tire radial direction of the land portion 10 adjacent inward in the tire width direction to the outermost circumferential main groove 21. Note that the reinforcing region 35 may be provided in other regions as well. For example, the reinforcing region 35 may be provided on the inner side in the tire radial direction of the land portion 10 adjacent inward in the tire width direction to the outermost circumferential main groove 21, and on the inner side in the tire radial direction of a land portion 10 adjacent inward in the tire width direction to the land portion 10 across the circumferential main groove 20 adjacent to the land portion 10.

In the circumferential reinforcing layer 75, the cord count of the circumferential reinforcing layer cords 30 per 50 mm in the tire width direction in the region on the inner side in the vehicle mounting direction that includes the reinforcing region 35 configured as stated above, that is, the average value Nin of the cord count of the circumferential reinforcing layer cords 30 on the inner side in the vehicle mounting direction is not less than 20 cords and not greater than 25 cords. In other words, in the circumferential reinforcing layer 75, the average cord count Nin of the circumferential reinforcing layer cords 30 in all regions on the inner side in the vehicle mounting direction, including the reinforcing region 35, is not less than 20 cords/50 mm and not greater that 25 cords/50 mm.

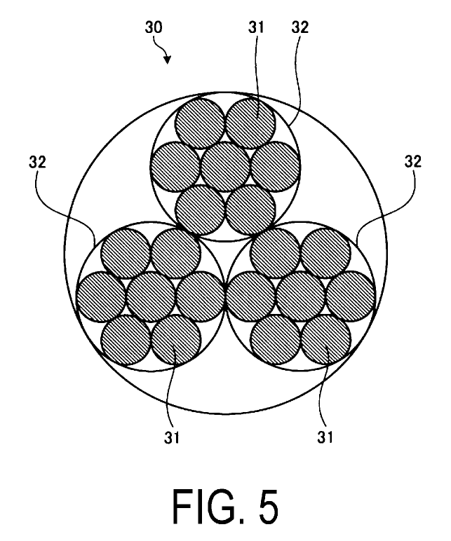

FIG. 5 is a cross-sectional view of a circumferential reinforcing layer cord. The circumferential reinforcing layer cords 30 of the circumferential reinforcing layer 75 are cords formed by twisting together a plurality of strands obtained by twisting a plurality of wires 31 together. That is, the circumferential reinforcing layer cords 30 are m×n type cords obtained by twisting together n strands 32 obtained by twisting together m wires 31. In the present embodiment, one of the circumferential reinforcing layer cords 30 is configured as a steel cord by twisting together three of the strands 32 obtained by twisting together seven wires 31 made from steel material. Additionally, the circumferential reinforcing layer cords 30 are so-called high elongation cords, which have high elongation characteristics. Note that it is preferable that not less than two and not greater than twelve of the wires 31 be used, and it is preferable that not less than two and not greater than five of the strands 32 be used.

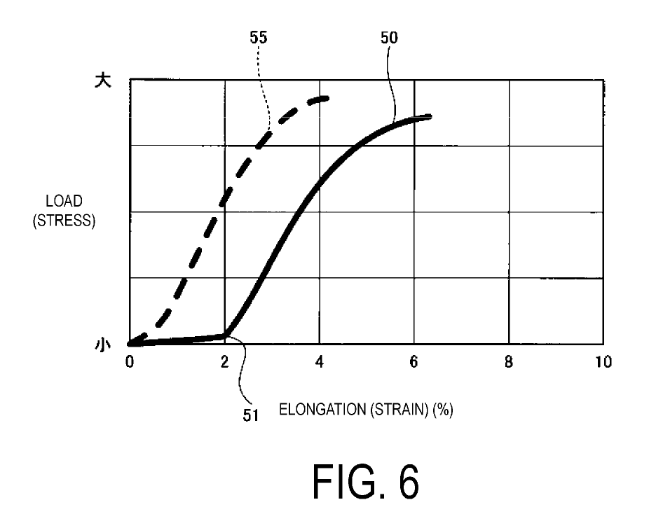

FIG. 6 is an explanatory diagram showing a stress-strain curve of the circumferential reinforcing layer cord. With the circumferential reinforcing layer cords 30 of the circumferential reinforcing layer 75, an inflection point 51 is located at a position where strain is 2.0% or greater on a pre-vulcanization curve 50. The pre-vulcanization curve 50 is a stress-strain curve of the circumferential reinforcing layer cords 30 prior to vulcanization of the pneumatic tire 1. That is, with the circumferential reinforcing layer cords 30,
there are differences in the degrees of change in elongation with respect to changes in tensile load on the pre-vulcanization curve 50, which shows the relationship between tensile load and elongation prior to vulcanization of the pneumatic tire 1, between when elongation is less than about 2.0% and when elongation is about 2.0% or greater. On the pre-vulcanization curve 50, the inflection point 51, where the degree of change in elongation with respect to changes in tensile load changes, is located at the position where the elongation of the circumferential reinforcing layer cord 30, with respect to the entire length of the circumferential reinforcing layer cord 30 when a tensile load is applied to the circumferential reinforcing layer cord 30, is 2.0% or greater. In other words, on the pre-vulcanization curve 50, the inflection point 51 of strain with respect to stress occurring in the circumferential reinforcing layer cord 30 is located where the strain is 2.0% or greater.

Additionally, the circumferential reinforcing layer cords 30 are configured such that the tensile modulus at 1.0% strain of a circumferential reinforcing layer cord 30, removed from the pneumatic tire 1 after vulcanization of the pneumatic tire 1, is 30 GPa or greater. That is, as shown in FIG. 6 by the post-vulcanization curve 55, which is a stress-strain curve of the circumferential reinforcing layer cords 30 after vulcanization, and the pre-vulcanization curve 50, strain with respect to stress is less after vulcanization than before vulcanization of the pneumatic tire 1. The circumferential reinforcing layer 75 is formed from circumferential reinforcing layer cords 30 that include steel cords having such characteristics.

It is preferable that the pneumatic tire 1 according to the present embodiment, which is configured as stated above and used as a heavy duty pneumatic tire, be used in cases where the nominal width is 355 mm or greater, the aspect ratio is 55% or less, and the rim diameter of the specified rim is 17.5 inches or greater. Additionally, when the pneumatic tire 1 according to the present embodiment is mounted on a vehicle, it is preferable that the pneumatic tire 1 be applied to a heavy duty pneumatic tire using a so-called single mounting method where one wheel is used at each mounting position of the vehicle, and not to so-called double-mounting methods where two wheels are stacked in the vehicle width direction and mounted.

When the pneumatic tire 1 according to the present embodiment is mounted on a vehicle, the pneumatic tire 1 is mounted on a vehicle in a state where the pneumatic tire 1 is assembled on the rim/wheel and inflated. When the vehicle on which the pneumatic tire 1 is mounted is driven, the pneumatic tire 1 rotates while the tread surface 3 located at the bottom of the tread surface 3 contacts the road surface. The vehicle travels by transferring driving force and braking force to the road surface, generating turning force, and the like, due to friction force between the tread surface 3 and the road surface.

While the vehicle is traveling, the pneumatic tire 1 rotates and, as such, centrifugal force is generated in the pneumatic tire 1 around the tire rotation axis. Due to the fastening effect, this centrifugal force is also generated in the belt layer 7 that reinforces the tread portion 2 to ensure rigidity and supports the carcass 6 and the tread portion 2 so as to form the shape of the whole tire. However, the belt layer 7 includes the circumferential reinforcing layer 75 in addition to the large-angle belt 71, the inner cross belt 72, and the outer cross belt 73. As such, the strength of the belt layer 7 with respect to tension in the tire circumferential direction is increased. That is, the circumferential reinforcing layer cords 30 that constitute the circumferential reinforcing layer 75 are disposed in a range of ±5° in the tire width direction with respect to the tire circumferential direction. As such, the circumferential reinforcing layer 75 of the belt layer 7 is less likely to elongate in the tire circumferential direction, and rigidity with respect to tension in the tire circumferential direction is ensured. As a result, even in cases where centrifugal force is generated in the belt layer 7 due to rotation of the pneumatic tire 1, the belt layer 7 is less likely to elongate in the tire circumferential direction due to the rigidity of the circumferential reinforcing layer 75 with respect to tension in the tire circumferential direction.

The belt layer 7 includes the circumferential reinforcing layer 75 stated above and, as such, basically is less likely to elongate in the tire circumferential direction. However, the belt layer 7 may slightly elongate due to the centrifugal force generated when the wheel is rotating. Particularly, elongation is comparatively more likely to occur during the period from the start of use of the pneumatic tire 1 as a new tire to when the members are broken in due to time passing in which the members elongate to an initial elongation. In other words, while the belt layer 7 is less likely to elongate in the tire circumferential direction as a result of including the circumferential reinforcing layer 75, it is likely that the diameter will increase slightly due to elongation in the tire circumferential direction during the period from the start of use of the pneumatic tire 1 as a new tire until a predetermined amount of time passes. This belt layer 7 also has a role of supporting the carcass 6 and the tread portion 2 and, thereby forming the shape of the whole tire. As such, in cases where elongation occurs in the belt layer 7 and the diameter thereof increases, the diameter of the tread portion 2 also increases along with the belt layer 7. That is, in cases where radial growth occurs due to the diameter of the belt layer 7 increasing, radial growth of the tread portion 2 also occurs and the diameter thereof also increases.

Here, the camber angle of wheels mounted on large vehicles is often set to a positive camber. As such, the ground contact pressure on the road surface of the tread surface 3 is different between positions outward and positions inward in the vehicle mounting direction. Specifically, it is likely that the ground contact pressure in the vicinity of the shoulder portion 4 on the inner side in the vehicle mounting direction will be lower than the ground contact pressure in the vicinity of the shoulder portion 4 on the outer side in the vehicle mounting direction. Centrifugal force is suppressed in regions where the ground contact pressure is high and, thus, in these portions, radial growth of the tread portion 2 and the belt layer 7 is suppressed an amount equal to the suppression of centrifugal force.

Thus, following the start of use of a new pneumatic tire 1, the radial growth of the tread portion 2 and the belt layer 7 in the vicinity of the shoulder portion 4 on the outer side in the vehicle mounting direction is likely to be less than the radial growth in the vicinity of the shoulder portion 4 on the inner side in the vehicle mounting direction. In other words, the radial growth of the tread portion 2 and the belt layer 7 in the vicinity of the shoulder portion 4 on the inner side in the vehicle mounting direction is likely to be greater than the radial growth of the tread portion 2 and the belt layer 7 in the vicinity of the shoulder portion 4 on the outer side in the vehicle mounting direction. As such, in cases where the radial growth in the vicinity of the shoulder portion 4 on the inner side in the vehicle mounting direction is great, wear is more likely to occur in the shoulder portion 4 on the inner side in the vehicle mounting direction than in the shoulder portion 4 on the outer side in the vehicle mounting direction and, as a result, uneven wear occurs.

In contrast, with the pneumatic tire 1 according to the present embodiment, in the circumferential reinforcing layer 75, the cord count of the circumferential reinforcing layer cords 30 is greater on the inner side in the vehicle mounting direction than on the outer side in the vehicle mounting direction. In other words, in the circumferential reinforcing layer 75, the density of the circumferential reinforcing layer cords 30 is greater on the inner side in the vehicle mounting direction than on the outer side in the vehicle mounting direction and, as such, rigidity with respect to tension in the tire circumferential direction increases. As a result, rigidity in the tire circumferential direction is increased on the inner side in the vehicle mounting direction of the belt layer 7 and, as such, radial growth is suppressed to a greater degree in the portions on the inner side in the vehicle mounting direction than in the portions on the outer side in the vehicle mounting direction of the belt layer 7 and the tread portion 2. Therefore, wear in the shoulder portion 4 on the inner side in the vehicle mounting direction can be suppressed to a greater degree than in the shoulder portion 4 on the outer side in the vehicle mounting direction. As a result, uneven wear on the inner side in the vehicle mounting direction can be suppressed.

Additionally, in the circumferential reinforcing layer 75, the relationship between the average value Nin of the cord count of the circumferential reinforcing layer cords 30 on the inner side in the vehicle mounting direction and the average value Nout of the cord count of the circumferential reinforcing layer cords 30 on the outer side in the vehicle mounting direction is such that 1.015≦(Nin/Nout)≦1.170. As such, uneven wear on the inner side in the vehicle mounting direction can be suppressed and, also, the occurrence of uneven wear in regions other than on the inner side in the vehicle mounting direction can be suppressed. In other words, if (Nin/Nout)<1.015, the increase in the cord count of the circumferential reinforcing layer cords 30 on the inner side in the vehicle mounting direction with respect to the cord count of the circumferential reinforcing layer cords 30 on the outer side in the vehicle mounting direction in the circumferential reinforcing layer 75 will be small. As such, it may be more difficult to ensure rigidity in the tire circumferential direction in the portion on the inner side in the vehicle mounting direction of the circumferential reinforcing layer 75. In this case, it will be difficult to appropriately suppress radial growth of the portions on the inner side in the vehicle mounting direction of the belt layer 7 and the tread portion 2, and it may be more difficult to suppress wear in the shoulder portion 4 on the inner side in the vehicle mounting direction. Additionally, if (Nin/Nout)>1.170, the increase in the cord count of the circumferential reinforcing layer cords 30 on the inner side in the vehicle mounting direction with respect to the cord count of the circumferential reinforcing layer cords 30 on the outer side in the vehicle mounting direction in the circumferential reinforcing layer 75 will be excessive. As such, the rigidity in the tire circumferential direction in the portion on the inner side in the vehicle mounting direction of the circumferential reinforcing layer 75 may become unnecessarily great. In this case, radial growth will be suppressed not only in the portions on the inner side in the vehicle mounting direction of the belt layer 7 and the tread portion 2 but, rather, radial growth in a surrounding region of the tire equatorial plane CL, namely a center portion, may be unnecessarily suppressed with respect to the portions on the outer side in the vehicle mounting direction. As such, uneven wear may occur in the center portion.

In contrast, when the relationship between Nin and Nout is such that 1.015≦(Nin/Nout)≦1.170, great wearing of the shoulder portion 4 on the inner side in the vehicle mounting direction compared to the shoulder portion 4 on the outer side in the vehicle mounting direction can be suppressed and, also, uneven wear caused by radial growth being unnecessarily suppressed in the center portion can be prevented. As a result, uneven wear on the inner side in the vehicle mounting direction can be suppressed and, also, uneven wear in the center portion can be suppressed.

In the circumferential reinforcing layer 75, the relationship between the width Win in the tire width direction of the reinforcing region 35 positioned on the inner side in the vehicle mounting direction and the width W in the tire width direction of the circumferential reinforcing layer 75 is such that 0.05≦(Win/W)≦0.30. As such, uneven wear on the inner side in the vehicle mounting direction can be suppressed and, also, uneven wear in regions other than on the inner side in the vehicle mounting direction can be suppressed. In other words, if (Win/W)<0.05, the width Win of the reinforcing region 35 will be excessively small and, as such, it may be more difficult to ensure the rigidity in the tire circumferential direction in the portion on the inner side in the vehicle mounting direction of the circumferential reinforcing layer 75. In this case, it will be difficult to appropriately suppress radial growth of the portions on the inner side in the vehicle mounting direction of the belt layer 7 and the tread portion 2, and it may be more difficult to suppress wear in the shoulder portion 4 on the inner side in the vehicle mounting direction. Additionally, if (Win/W)<0.30, the width Win of the reinforcing region 35 will be excessively great and, as such, the rigidity in the tire circumferential direction in the portion on the inner side in the vehicle mounting direction of the circumferential reinforcing layer 75 may become unnecessarily great. In this case, radial growth will be suppressed not only in the portions on the inner side in the vehicle mounting direction of the belt layer 7 and the tread portion 2 but, rather, radial growth in the center portion may also be unnecessarily suppressed and, as a result, uneven wear may occur in the center portion.

In contrast, when the relationship between the width Win of the reinforcing region 35 of the circumferential reinforcing layer 75 and the width W of the circumferential reinforcing layer 75 is such that 0.05≦(Win/W)≦0.30, great wearing of the shoulder portion 4 on the inner side in the vehicle mounting direction compared to the shoulder portion 4 on the outer side in the vehicle mounting direction can be suppressed and, also, the occurrence of uneven wear in the center portion can be suppressed. As a result, uneven wear on the inner side in the vehicle mounting direction can be suppressed and, also, uneven wear in the center portion can be suppressed.

Additionally, the relationship between the width W in the tire width direction of the circumferential reinforcing layer 75 and the developed tread width T is such that 0.7≦(W/T)≦0.8. As such, radial growth of the pneumatic tire 1 can be reliably suppressed and durability of the circumferential reinforcing layer 75 can be ensured. In other words, if (W/T)≦0.7, the width W of the circumferential reinforcing layer 75 with respect to the developed tread width T will be excessively small and, as such, it may be difficult to effectively suppress radial growth of the belt layer 7 by the circumferential reinforcing layer 75. In this case, it is difficult to suppress radial growth of the whole pneumatic tire 1 by the belt layer 7 when centrifugal force acts on the pneumatic tire 1 and, as such, the tread portion 2 and the like may be more likely to deform due to centrifugal force and durability may decline. Additionally, if (W/T)>0.8, the width W of the circumferential reinforcing layer 75 with respect to the developed tread width T will be excessively great and, as such, the end portions in the tire width direction of the circumferential reinforcing layer 75 may be too close to the shoulder portions 4 of the tread portion 2. Deformation when the vehicle is traveling is great in the vicinity of the shoulder portions 4 of the tread portion 2 and, as such, if the end portions of the circumferential reinforcing layer 75 are too close to the shoulder portions 4, the circumferential reinforcing layer 75 may deform as a result of the vicinities of the shoulder portions 4 of the tread portion 2 greatly deforming, and the circumferential reinforcing layer cords 30 may break.

In contrast, when the relationship between the width W in the tire width direction of the circumferential reinforcing layer 75 and the developed tread width T is such that 0.7≦(W/T)≦0.8, radial growth of the whole pneumatic tire 1 can be suppressed by the circumferential reinforcing layer 75 and, also, durability of the circumferential reinforcing layer 75 can be ensured. As a result, durability of the pneumatic tire 1 can be enhanced.

The cord count of the circumferential reinforcing layer cords 30 of the circumferential reinforcing layer 75 per 50 mm in the tire width direction in the region on the inner side in the vehicle mounting direction is not less than 20 cords and not greater than 25 cords. As such, radial growth of the region on the inner side in the vehicle mounting direction of the circumferential reinforcing layer 75 can be more reliably suppresses and, also, durability of the circumferential reinforcing layer 75 can be ensured. In other words, if the cord count of the circumferential reinforcing layer cords 30 in the region on the inner side in the vehicle mounting direction of the circumferential reinforcing layer 75 is less than 20 cords/50 mm, it may be difficult to effectively suppress radial growth of the region on the inner side in the vehicle mounting direction in the circumferential reinforcing layer 75. In this case, it may be more difficult to suppress the shoulder portion 4 on the inner side in the vehicle mounting direction from being more prone to wear than the shoulder portion 4 on the outer side in the vehicle mounting direction, and durability may decline as a result of radial growth of the tread portion 2. Additionally, if the cord count of the circumferential reinforcing layer cords 30 in the region on the inner side in the vehicle mounting direction of the circumferential reinforcing layer 75 is greater than 25 cords/50 mm, the density of the circumferential reinforcing layer cords 30 will be excessively high and, as a result, it will be more likely that the circumferential reinforcing layer cords 30 will contact each other and the cords may break.

In contrast, when the cord count of the circumferential reinforcing layer cords 30 on the inner side in the vehicle mounting direction of the circumferential reinforcing layer 75 is not less than 20 cords and not greater than 25 cords, radial growth of the region on the inner side in the vehicle mounting direction of the circumferential reinforcing layer 75 can be more reliably suppressed without the circumferential reinforcing layer cords 30 breaking. As a result, uneven wear on the inner side in the vehicle mounting direction can be more reliably suppressed and, also, durability of the circumferential reinforcing layer 75 can be ensured.

The circumferential reinforcing layer cords 30 of the circumferential reinforcing layer 75 are cords having high elongation characteristics, and are obtained by twisting together a plurality of strands 32 formed by twisting together a plurality of wires 31. As such, ease of manufacture of the pneumatic tire 1 can be ensured because the circumferential reinforcing layer 75 elongates in the tire circumferential direction in an appropriate range and, also, rigidity in the tire circumferential direction of the circumferential reinforcing layer 75 is ensured. As a result, uneven wear on the inner side in the vehicle mounting direction can be reliably and easily suppressed.

With the circumferential reinforcing layer cords 30 of the circumferential reinforcing layer 75, the inflection point 51 is located at the position where strain is 2.0% or greater on a stress-strain curve of pneumatic tire 1 before vulcanization, and the circumferential reinforcing layer cords 30 are steel cords for which the tensile modulus at 1.0% strain is 30 GPa or greater after vulcanization. As such, ease of radial expansion of the circumferential reinforcing layer 75 when vulcanizing and difficulty of radial growth after vulcanization can both be achieved in a compatible manner. In other words, when the relationship between the stress and the strain of the circumferential reinforcing layer cords 30 is shown as the pre-vulcanization curve 50, if the inflection point 51 is located at the position where strain is less than 2.0%, the circumferential reinforcing layer 75 may be less likely to follow the radial expansion when radially expanding the pneumatic tire 1 in a mold during vulcanization and, manufacturability may decline. Additionally, when the circumferential reinforcing layer 75 is configured such that the tensile modulus at 1.0% strain of a circumferential reinforcing layer cord 30, removed from the pneumatic tire 1 after vulcanization of the pneumatic tire 1, is less than 30 GPa, the tensile strength of the circumferential reinforcing layer cords 30 may be insufficient, and it may be difficult to ensure the appropriate rigidity in the tire circumferential direction of the circumferential reinforcing layer 75. In this case, it may be difficult to suppress radial growth of the belt layer 7 by the circumferential reinforcing layer 75, and it may be difficult to appropriately suppress radial growth of the whole pneumatic tire 1.

In contrast, when the circumferential reinforcing layer cords 30 of the circumferential reinforcing layer 75 are configured such that the inflection point 51 is located at the position on the pre-vulcanization curve 50 where strain is 2.0% or greater, and the tensile modulus at 1.0% strain after vulcanization is 30 GPa or greater, ease of radial expansion of the circumferential reinforcing layer 75 when vulcanizing and difficulty of radial growth after vulcanization can both be achieved in a compatible manner. As a result, durability can be ensured and, also, manufacturability of the pneumatic tire 1 can be more reliably ensured.

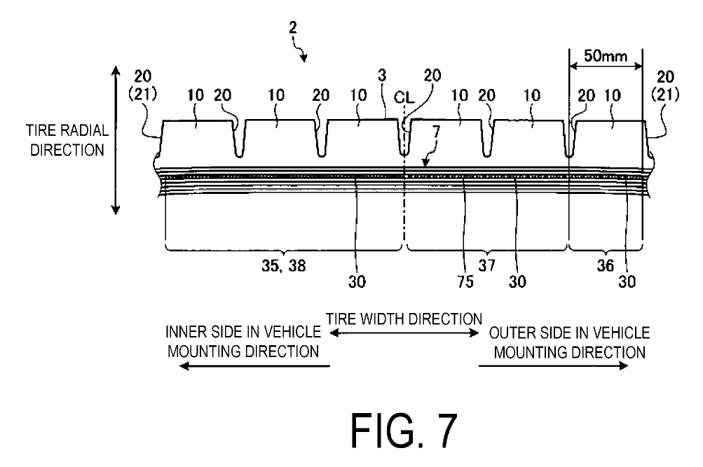

Note that, with the pneumatic tire 1 according to the embodiment stated above, the reinforcing region 35 of the circumferential reinforcing layer 75 is provided in the predetermined range from the end portion on the inner side in the vehicle mounting direction, but a configuration is possible in which the reinforcing region 35 is provided in a wider region. FIG. 7 is an explanatory diagram of a modified example of the pneumatic tire according to the embodiment, illustrating a case in which the reinforcing region is provided throughout the entire inner side in the vehicle mounting direction. As illustrated in FIG. 7, the reinforcing region 35 of the circumferential reinforcing layer 75 may be provided throughout a region, of the circumferential reinforcing layer 75, positioned inward in the vehicle mounting direction from the tire equatorial plane CL. That is, the reinforcing region 35 of the circumferential reinforcing layer 75 may be provided throughout the entirety of a vehicle mounting inner side region 38. In cases where the reinforcing region 35 is provided throughout the entirety of the vehicle mounting inner side region 38, rigidity in the tire circumferential direction of the circumferential reinforcing layer 75 can be ensured to a greater degree in the region of the circumferential reinforcing layer 75 positioned on the inner side in the vehicle mounting direction than in the region positioned on the outer side in the vehicle mounting direction. Therefore, radial growth can be suppressed to a greater degree in the portions on the inner side in the vehicle mounting direction than in the portions on the outer side in the vehicle mounting direction of the belt layer 7 and the tread portion 2, and wear in the shoulder portion 4 on the inner side in the vehicle mounting direction can be suppressed to a greater degree than in the shoulder portion 4 on the outer side in the vehicle mounting direction. As a result, uneven wear on the inner side in the vehicle mounting direction can be suppressed.

With the pneumatic tire 1 according to the embodiment stated above, a configuration is possible in which the belt layer 7 includes an edge cover (not illustrated in the drawings). Typically, an edge cover is constituted by a plurality of belt cords formed from steel or an organic fiber material covered by coating rubber and subjected to a rolling process. Additionally, a belt angle of the edge cover, namely an inclination angle of the belt cords in the tire width direction with respect to the tire circumferential direction, is not less than 0° and not greater than 5° as an absolute value. Additionally, the edge cover is disposed on the outer side in the tire radial direction of the edge portions in the tire width direction of the outer cross belt 73 or, alternatively, the inner cross belt 72. The edge cover can increase the fastening effect of the belt layer 7 and, as such, can reduce the difference in radial growth between the region in the vicinity of the center portion and the regions in the vicinities of the shoulder portions 4 of the tread portion 2.

Additionally, in the pneumatic tire 1 according to the embodiment stated above, the circumferential reinforcing layer 75 is interposed between the inner cross belt 72 and the outer cross belt 73, but a configuration is possible in which the circumferential reinforcing layer 75 is disposed at a different location. For example, configurations are possible in which the circumferential reinforcing layer 75 is disposed inward in the tire radial direction of the inner cross belt 72 or is disposed outward in the tire radial direction from the outer cross belt 73. In cases where the circumferential reinforcing layer 75 is disposed inward in the tire radial direction of the inner cross belt 72, the circumferential reinforcing layer 75 may be disposed between the inner cross belt 72 and the large-angle belt 71, or may be disposed between the large-angle belt 71 and the carcass 6. Regardless of the location where the circumferential reinforcing layer 75 is disposed, the circumferential reinforcing layer 75 is configured such that the cord count of the circumferential reinforcing layer cords 30 is greater on the inner side in the vehicle mounting direction than on the outer side in the vehicle mounting direction, based on the tire equatorial plane CL. As a result, the circumferential reinforcing layer 75 can suppress radial growth on the inner side in the vehicle mounting direction of the tread portion 2, wear can be suppressed to a greater degree in the shoulder portion 4 on the inner side in the vehicle mounting direction than in the shoulder portion 4 on the outer side in the vehicle mounting direction, and the occurrence of uneven wear can be suppressed.

### EXAMPLES

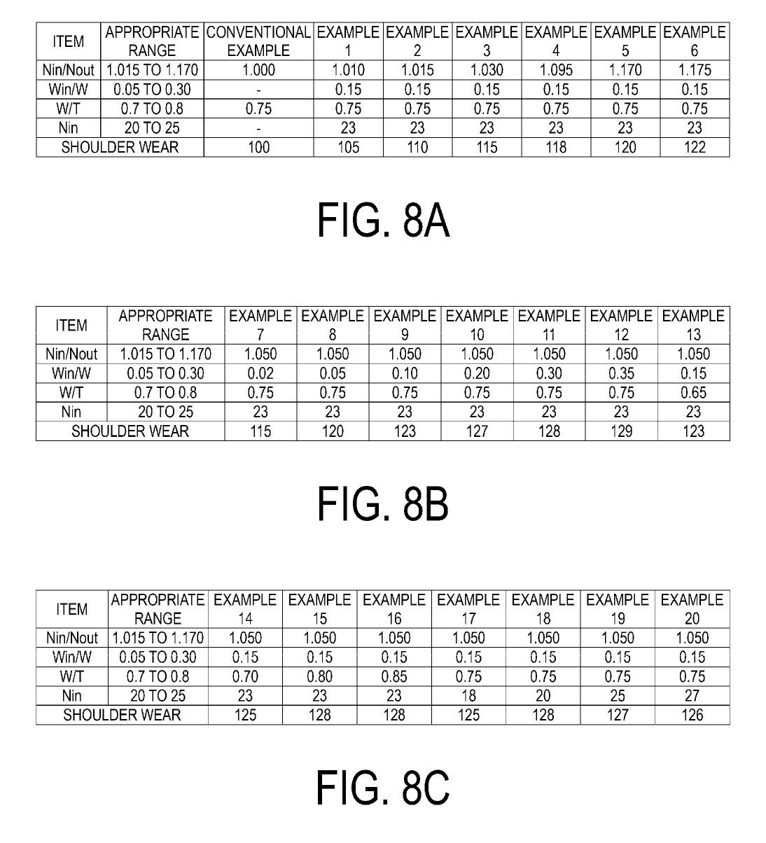

FIGS. 8A to 8C are tables showing the results of performance tests of pneumatic tires. For the pneumatic tire 1 stated above, performance evaluation testing conducted with respect to a pneumatic tire of a conventional example and pneumatic tires 1 according to the present technology will be stated below. In the performance evaluation testing, testing for shoulder wear was performed.

In the performance evaluation testing, a pneumatic tire 1 having a nominal width defined by JATMA of 445/50R22.5 was assembled on a 22.5×14.00 JATMA standard rim and the air pressure thereof was adjusted to the maximum air pressure (830 kPa) defined by JATMA. Test traveling was carried out in a state where the pneumatic tire 1 was mounted on a 2-axle trailer (test vehicle) and loaded to the maximum load defined by JATMA.

Evaluation method for shoulder wear: The test vehicle was driven for 100000 km and, thereafter, the degree of wear in the shoulder portion 4 on the inner side in the vehicle mounting direction with respect to the wear in the shoulder portion 4 on the outer side in the vehicle mounting direction was measured. The shoulder wear was evaluated calculating index values, where the degree of wear in the shoulder portion 4 on the inner side in the vehicle mounting direction with respect to the wear in the shoulder portion 4 on the outer side in the vehicle mounting direction of the pneumatic tire 1 of the Conventional Example (stated below) was set to 100. Larger index values indicate superior shoulder wear. Specifically, larger index values of the evaluation results indicate the difference is small between the wear in the shoulder portion 4 on the outer side in the vehicle mounting direction and the wear in the shoulder portion 4 on the inner side in the vehicle mounting direction.

Evaluation testing was performed for 21 types of pneumatic tires 1, namely a pneumatic tire of a Conventional Example, which is an example of a conventional pneumatic tire, and pneumatic tires 1 of Examples 1 to 20, which are pneumatic tires 1 according to the present technology. The circumferential reinforcing layer 75 was provided in all of these pneumatic tires 1. The reinforcing region 35 was not provided in the circumferential reinforcing layer 75 of the pneumatic tire of the Conventional Example. In contrast, the reinforcing region 35 was provided in the circumferential reinforcing layer 75 of all of the pneumatic tires 1 of Examples 1 to 20, which are examples of the pneumatic tire 1 according to the present technology. Furthermore, in the pneumatic tires 1 according to Examples 1 to 20, the relationship between the average value Nin of the cord count of the circumferential reinforcing layer cords 30 on the inner side in the vehicle mounting direction and an average value Nout of the cord count of the circumferential reinforcing layer cords 30 on the outer side in the vehicle mounting direction, the relationship between the width W of the circumferential reinforcing layer 75 and the width Win of the reinforcing region 35, the relationship between the width W of the circumferential reinforcing layer 75 and the developed tread width T, and the average value Nin of the cord count of the circumferential reinforcing layer cords 30 on the inner side in the vehicle mounting direction were varied.

It is clear from the results of the evaluation testing using these pneumatic tires 1 shown in FIGS. 8A to 8C that the difference between wear in the shoulder portion 4 on the outer side in the vehicle mounting direction and wear in the shoulder portion 4 on the inner side in the vehicle mounting direction was smaller for the pneumatic tires 1 according to Examples 1 to 20 than for the Conventional Example. That is, the pneumatic tire 1 according to Examples 1 to 20 can suppress uneven wear on the inner side in the vehicle mounting direction.

1. A pneumatic tire comprising:
a tread portion; and
a belt layer including a plurality of belt plies on an inner side in a tire radial direction of the tread portion; wherein
a mounting direction of the pneumatic tire on a vehicle is specified,
the belt layer includes a circumferential reinforcing layer, cords being disposed side by side in a tire width direction in the circumferential reinforcing layer, the cords being inclined with respect to a tire circumferential direction within a range of ±5° in the tire width direction, and
a cord count, namely a number of the cords in the tire width direction, of the circumferential reinforcing layer is greater on an inner side in a vehicle mounting direction than on an outer side in the vehicle mounting direction, based on a tire equatorial plane.

2. The pneumatic tire according to claim 1, wherein:
a relationship between an average value Nin of the cord count of the cords on the inner side in the vehicle mounting direction and an average value Nout of the cord count of the cords on the outer side in the vehicle mounting direction of the circumferential reinforcing layer is such that 1.015≦(Nin/Nout)≦1.170.

3. The pneumatic tire according to claim 1, wherein:
the circumferential reinforcing layer includes a reinforcing region, namely a region where an average cord count of the cords is greater than an average cord count of the cords in a range from an edge portion on the outer side in the vehicle mounting direction to 50 mm inward in the tire width direction, in a predetermined range inward in the tire width direction from an edge portion on the inner side in the vehicle mounting direction; and
a relationship between a width Win in the tire width direction of the reinforcing region and a width W in the tire width direction of the circumferential reinforcing layer is such that 0.05≦(Win/W)≦0.30.

4. The pneumatic tire according to claim 1, wherein:
a relationship between the width W in the tire width direction of the circumferential reinforcing layer and a developed tread width T is such that 0.7≦(W/T)≦0.8.

5. The pneumatic tire according to claim 1, wherein:
a cord count of the cords of the circumferential reinforcing layer per 50 mm in the tire width direction in the region on the inner side in the vehicle mounting direction is not less than 20 cords and not greater than 25 cords.

6. The pneumatic tire according to claim 1, wherein:
the cords of the circumferential reinforcing layer are cords having high elongation characteristics, obtained by twisting together a plurality of strands formed by a plurality of wires that are twisted together.

7. The pneumatic tire according to claim 2, wherein:
the circumferential reinforcing layer includes a reinforcing region, namely a region where an average cord count of the cords is greater than an average cord count of the cords in a range from an edge portion on the outer side in the vehicle mounting direction to 50 mm inward in the tire width direction, in a predetermined range inward in the tire width direction from an edge portion on the inner side in the vehicle mounting direction; and
a relationship between a width Win in the tire width direction of the reinforcing region and a width W in the tire width direction of the circumferential reinforcing layer is such that 0.05≦(Win/W)≦0.30.

8. The pneumatic tire according to claim 7, wherein:
a relationship between the width W in the tire width direction of the circumferential reinforcing layer and a developed tread width T is such that 0.7≦(W/T)≦0.8.

9. The pneumatic tire according to claim 8, wherein:
a cord count of the cords of the circumferential reinforcing layer per 50 mm in the tire width direction in the region on the inner side in the vehicle mounting direction is not less than 20 cords and not greater than 25 cords.

10. The pneumatic tire according to claim 9, wherein:
the cords of the circumferential reinforcing layer are cords having high elongation characteristics, obtained by twisting together a plurality of strands formed by a plurality of wires that are twisted together.
